(19) United States
(12) Patent Application Publication
(10) Pub. No.: US 2005/0095903 A1
(43) Pub. Date: May 5, 2005

(54) Take-up cassette for holding a cable of a sliding guide device and method for mounting the take-up cassette

(75) Inventors: Alexander Stenzel, Bad Windsheim (DE); Martin Pfister, Prichsenstadt (DE)

Correspondence Address: LERNER AND GREENBERG, PA, P O BOX 2480, HOLLYWOOD, FL, 33022-2480, US

(73) Assignee: LEONI Bordnetz-Systeme GmbH & Co. KG

(21) Appl. No.: 10/981,999

(22) Filed: Nov. 5, 2004

(30) Foreign Application Priority Data
Nov. 5, 2003 (DE) 103 52 207.6
Dec. 6, 2003 (DE) 103 57 139.6

(51) Int. Cl. H01R 13/72

(52) U.S. Cl. 439/501

(57) ABSTRACT

To permit simple mounting of a take-up cassette, for example, in a constricted mounting space of a doorsill of a motor vehicle, a flexible housing is variable to form a desired final geometry for mounting purposes. The take-up cassette is used to hold a cable by which, in particular, a sliding door of a motor vehicle is connected to its onboard power system.

### BACKGROUND OF THE INVENTION

### Field of the Invention

The invention relates to a take-up cassette for holding a cable of a sliding guide device and for being disposed in a constricted mounting space. The invention also relates to a method for mounting such a take-up cassette in a constricted mounting space, in particular, for mounting in a bodywork element of a motor vehicle for electrically connecting a sliding door to the onboard power supply system of a motor vehicle.

The sliding guide device is understood to be a device that is composed of a fixed part and a sliding part that is guided in a sliding fashion, for example, in rails of the fixed part. A sliding guide device is, for example, a sliding door, in particular, a sliding door for a motor vehicle. Sliding doors for a motor vehicle having an electrical connection to the onboard power system are disclosed, for example, in German Published, Non-Prosecuted Patent Application DE 102 29 655 A1, corresponding to U.S. Pat. No. 6,796,834 to Shigeru et al., or European Patent Application EP 1 010 558 A2, corresponding to U.S. Pat. No. 6,174,020 to Knettle et al. In this context, to form a permanent electrical connection to the onboard power system there is provision for a permanent electrical connection to be made between the fixed bodywork and the slidingly mounted sliding door by a cable. The cable is, therefore, guided by the bodywork into the sliding door. Due to the position that can be varied by the sliding bearing of the sliding door over a wide displacement range, a long section of the cable has to be made to follow or rolled up.

For such a purpose, for example, a take-up cassette that is embodied as a roll-up housing for the cable is provided. The cable is automatically stored in this cassette when the sliding door closes or opens. Due to the large displacement range of the sliding door, the take-up cassette must have a large receptacle space for the relatively long cable. For this reason, the take-up cassette is, generally, bulky, leading to problems during mounting because, often, only a very constricted mounting space is available. For example, the cavity in the doorsill of a front door is provided for the take-up cassette.

### SUMMARY OF THE INVENTION

It is accordingly an object of the invention to provide a take-up cassette for holding a cable of a sliding guide device and a method for mounting the take-up cassette that overcome the hereinafore-mentioned disadvantages of the heretofore-known devices and methods of this general type and that permits the take-up cassette to be mounted easily.

With the foregoing and other objects in view, there is provided, in accordance with the invention, a take-up cassette for holding a cable of a sliding guide device and for being mounted in a constricted mounting space, including a housing having a final mounted position and a predefined final geometry in the final mounted position, the housing having a variable geometry with respect to the predefined final geometry for mounting the housing in the final mounted position.

With the objects of the invention in view, there is also provided a take-up cassette for holding a cable of a sliding guide device and for being mounted in a constricted mounting space, including a housing having a final mounted position and a predefined final geometry in the final mounted position, the housing having a variable geometry with respect to the predefined final geometry for mounting the housing in the final mounted position and a plurality of component pieces moving in relation to one another for mounting the housing in the final mounting position.

With the objects of the invention in view, there is also provided a take-up cassette for holding a cable for electrically connecting a sliding door to the onboard power system of a motor vehicle, including a housing having a final mounted position and a predefined final geometry in the final mounted position, the housing having a variable geometry with respect to the predefined final geometry for mounting the housing in the final mounted position.

Accordingly, the take-up cassette has a housing that has a predefined final geometry in the final mounted position, the geometry of the housing being variable with respect to the final geometry for mounting purposes.

This embodiment is based on the idea that, due to the large receptacle space that is necessary for the cable, the necessary final geometry of the housing no longer permits mounting in a predefined constricted mounting space. Taking this as the starting point, the housing is, therefore, constructed such that it is not converted to the predefined final geometry until during or after the mounting, and before this has a geometry that permits mounting in the constricted mounting space. For such a purpose, the housing has an overall flexible configuration with respect to its geometry and, for example, one that is bendable or flexurally elastic. As a result, during mounting, the housing can be, as it were, threaded in or introduced into the constricted mounting space along a curve and does not assume its linear, for example, parallelepiped-shaped, final geometry until it is there.

In accordance with another feature of the invention, the housing has a plurality of component pieces that can be moved in relation to one another for mounting purposes. The take-up cassette is, therefore, flexible by virtue of a multi-element configuration so that it can be mounted comparatively easily. For such a purpose, in expedient embodiments, the component pieces are connected to one another in a telescopic or, else, pivotable fashion. During the pivotable connection, the component pieces are, preferably, attached to one another by a hinge that is disposed at the edge. Alternatively, the component pieces are attached to one another so as to be capable of pivoting about a central bearing axis. The end sides of the component pieces are constructed in the manner of a bearing shell so as to be complementary to one another. This configuration in the manner of a bearing shell allows the individual component pieces to pivot laterally in two directions with respect to one another so that the housing can also be introduced into the mounting space along a meandering line or S line.

In accordance with a further feature of the invention, the individual component pieces can be latched expediently to one another in the final mounted position so that, after mounting, a stable, inherently rigid housing, whose geometry can no longer be changed, is obtained. In the embodiment with the hinge that is disposed at the edge, this latching function is, preferably, provided by the hinge. As soon as, for example, two component pieces that follow one another are oriented in a straight line with respect to one another, they are latched automatically to one another at the hinge so that the hinge function is cancelled.

In accordance with an added feature of the invention, the housing has two opposite ends and flexible, in particular, textile side walls. For the purpose of mounting, the ends are displaced along a guide element in the longitudinal direction of the housing. The guide element is, preferably, telescopic. This measure allows the parallelepiped-shaped housing that is, usually, elongated in its final geometry to be pushed together over a very short length for mounting purposes so that, due to the short length, simple insertion or threading in into the constricted mounting space is made possible. Only then is the housing extended to its full size by pulling at the front end. The guide element is, for example, a rod or a linkage composed of a plurality of rods, in particular, telescopic rods, which each extend over the entire length of the final geometry in the pulled-out state. In such a context, the linkage and/or the rod is flexible advantageously, in particular, flexurally elastic, so that the rod or the linkage does not pose any problems during mounting.

In accordance with an additional feature of the invention, the housing is foldable. In such a context, the housing can, for example, be folded along its length, i.e., the length of the housing is reduced by the fold so that the housing can easily be introduced into the mounting space due to the reduced length of the housing. However, the housing can be folded, preferably, in the transverse direction so that the width of the housing is significantly shorter in the folded state in comparison with the final geometry. For the purpose of mounting, the housing, therefore, forms only one narrow strip and, preferably, has a small degree of inherent rigidity and a high degree of flexural elasticity. Both the short width and the flexural elasticity are advantageous for mounting in the constricted mounting space.

In accordance with yet another feature of the invention, the housing is embodied in the manner of a corrugated tube, and, due to its construction as a corrugated tube, it has a flexural elasticity that permits mounting along a bowed curve. In accordance with yet a further feature of the invention, to ensure flexibility, the housing has movement slots or bending slots that are disposed distributed transversely with the longitudinal axis over the longitudinal extent of the housing.

When the cable is introduced into the take-up cassette repeatedly, there is the risk of particles of dust also being introduced and, in the course of time, these particles could adversely affect, for example, the rolling up or unrolling of the cable in the take-up cassette. To prevent this, in accordance with yet an added feature of the invention, there is provided a textured base for the housing is provided. The base, therefore, has elevations and depressions, it being possible for the dust to collect in the depressions and for the cable to continue to be guided on the elevations without being adversely affected by the particles of dust. For example, the base is provided with a corrugated structure or the housing has an overall construction in the manner of a corrugated tube. The embodiment of the housing with a textured base is not restricted to flexible housings whose geometry can be varied for mounting purposes. Instead, regardless thereof, the textured embodiment is, preferably, also used in a housing with a fixed geometry.

With the objects of the invention in view, there is also provided a method for mounting a take-up cassette for a cable of a sliding guide device in a constricted mounting space, including the steps of providing a take-up cassette with a housing having a variable geometry, introducing the take-up cassette into the mounting space during mounting, and changing the geometry of the housing in at least one of the mounting process of the housing and subsequent to the mounting process of the housing to form a predefined final geometry of the housing.

With the objects of the invention in view, there is also provided a method for mounting a take-up cassette for a cable of a sliding guide device in a constricted mounting space in a bodywork element of a motor vehicle for electrically connecting a sliding door to an onboard power system of a motor vehicle, including the steps of providing a take-up cassette with a housing having a variable geometry, introducing the take-up cassette into the mounting space during mounting, and changing the geometry of the housing in at least one of the mounting process of the housing and subsequent to the mounting process of the housing to form a predefined final geometry of the housing.

With the objects of the invention in view, there is also provided a method for mounting a take-up cassette for a cable of a sliding guide device in a sliding door of a motor vehicle for electrically connecting a sliding door to an onboard power system of a motor vehicle, including the steps of introducing a take-up cassette having a housing with a variable geometry into a constricted mounting space in a bodywork element of a motor vehicle, and changing the geometry of the housing in at least one of the mounting process of the housing; and subsequent to the mounting process of the housing to form a predefined final geometry of the housing.

According to the invention, the advantages as described with respect to the take-up cassette and preferred embodiments can correspondingly also be applied to the method.

Other features that are considered as characteristic for the invention are set forth in the appended claims.

Although the invention is illustrated and described herein as embodied in a take-up cassette for holding a cable of a sliding guide device and a method for mounting the take-up cassette, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1A is a fragmentary, perspective view of a take-up cassette according to the invention with a cable in the assembled state;

FIG. 1B is a fragmentary, exploded perspective view of the take-up cassette of FIG. 1A with the cable;

FIG. 2 is a fragmentary, perspective view of a take-up cassette according to the invention mounted in a bodywork element of a motor vehicle and having a cable,

FIG. 3A is a perspective view of a second embodiment of a housing according to the invention of component pieces that can be slid with respect to one another in a telescopic fashion;

FIG. 3B is a fragmentary, enlarged view of a portion of the housing of FIG. 3A;

FIG. 4A is a perspective view of a third embodiment of a housing according to the invention having component pieces each pivotable in relation to one another on both sides about a central bearing axis;

FIG. 4B is an enlarged, perspective view of a portion of the housing of FIG. 4A;

FIG. 5A is a perspective view of a fourth alternative embodiment of a housing according to the invention with ends displaceable along rods and with a textile covering clamped therebetween;

FIG. 5B is a perspective view of the housing of FIG. 5A with a portion of the textile covering removed;

FIG. 6A is a perspective view of a fifth embodiment of a housing according to the invention that can be folded transversely with respect to its longitudinal extent;

FIG. 6B is an enlarged, fragmentary, perspective view of the housing of FIG. 6A showing both the open and closed positions;

FIG. 7A is a perspective view of a sixth embodiment of a housing according to the invention having component pieces pivotable against one another at edges thereof by a hinge;

FIG. 7B is a fragmentary, enlarged, partially hidden, perspective view of the housing of FIG. 7A with the hinge shown inside of the housing;

FIG. 8 is a fragmentary view of a seventh embodiment of a housing according to the invention embodied as a corrugated tube;

FIG. 9 is a perspective view of an eighth embodiment of a housing according to the invention having transversely extending movement slots distributed over a longitudinal extent thereof;

FIG. 10A is a fragmentary perspective view of a foldable housing according to the invention being mounted into a bodywork element;

FIG. 10B is a fragmentary, perspective view of the housing of FIG. 10A mounted in the bodywork element;

FIG. 11A is a fragmentary, perspective view of a housing according to the invention having a geometry that cannot be varied; and

FIG. 11B is a fragmentary, perspective view of the housing of FIG. 11A mounted in a bodywork element.

### DESCRIPTION OF THE PREFERRED EMBODIMENTS

In the figures of the drawings, unless stated otherwise, identical reference symbols denote identical parts.

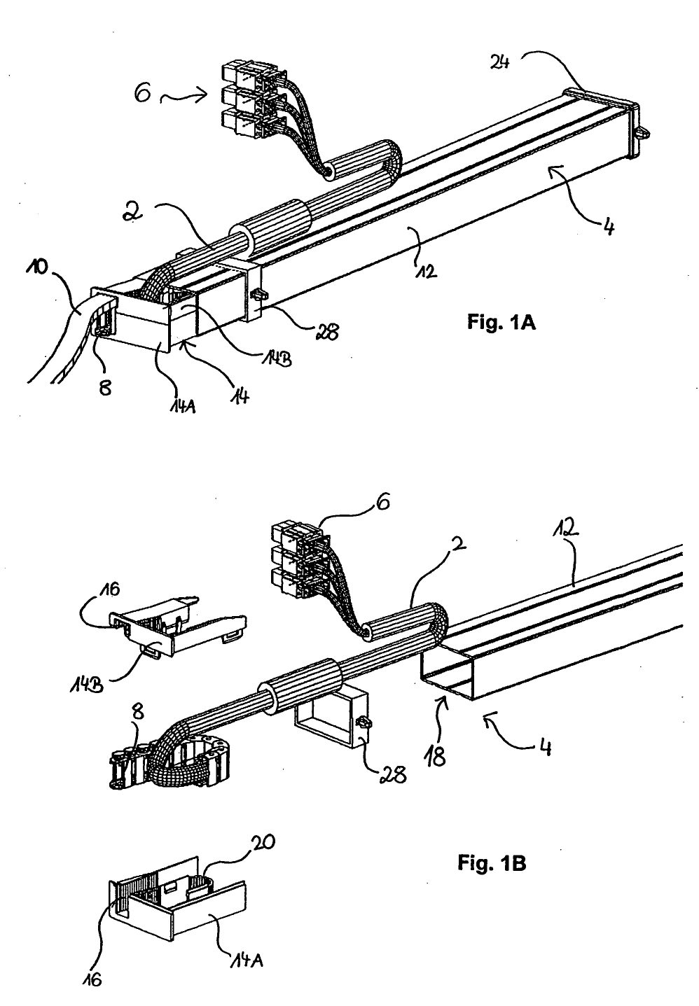

According to FIGS. 1A and 1B, a cable 2 is connected as a component piece of an onboard power system of a motor vehicle to a take-up cassette 4 that is embodied as a roll-up housing. The cable 2 has, at one of its ends, a plug configuration 6 with which it is connected to the onboard power system that is permanently connected to the bodywork. At the other end, the cable 2 is routed in a cable-guiding element that is embodied as a chain 8 of elements to a non-illustrated sliding door. The chain 8 of elements is routed here by a guide rail 10, as is apparent from FIG. 1A.

In the exemplary embodiment in FIGS. 1A, 1B, the take-up cassette 4 includes a foldable housing 12 and an insertion element 14 at the end. The insertion element 14 is of a two-part configuration and includes a lower part 14A and an upper part 14B that can, for example, be latched to the latter. The insertion element 14 has an end opening 16 through which the chain 8 of elements is guided. Furthermore, the upper part 14B in the exemplary embodiment in FIGS. 1A, 1B is open at the top so that the cable 2 can be led out at the top of the receptacle space 18 that is enclosed by the take-up cassette 4. The insertion element 14 is, for example, only partially inserted or plugged into the housing 12 here so that the housing 12 is continued in the forward direction by the insertion element 14, and the interior of the insertion element 14 is accessible from above.

In the lower part 14A, a guide 20 that is approximately U-shaped, and that is formed by a wall that extends in a U-shape is provided. Specifically, the guide 20 is disposed between the opening 16 and the exit point of the cable 2 at the top. The chain 8 of elements is inserted or guided around the guide 20. For example, when the sliding door closes, the cable 2 is held in the take-up cassette 4 by virtue of the fact that the chain 8 of elements is pushed, with the cable 2 routed in it, into the receptacle space 18 through the opening 16. The U curvature of the chain 8 of elements that can be seen in FIG. 1B migrates toward the rear in the housing 12 here. Conversely, when the sliding door opens, the chain 8 of elements is led out again, at maximum up to the point at which the curvature of the chain 8 of elements come to bear against the guide 20. To be on the safe side and to ensure tensile relief of the cable 2, the first element of the chain 8 of elements is secured, preferably, in the insertion element 14.

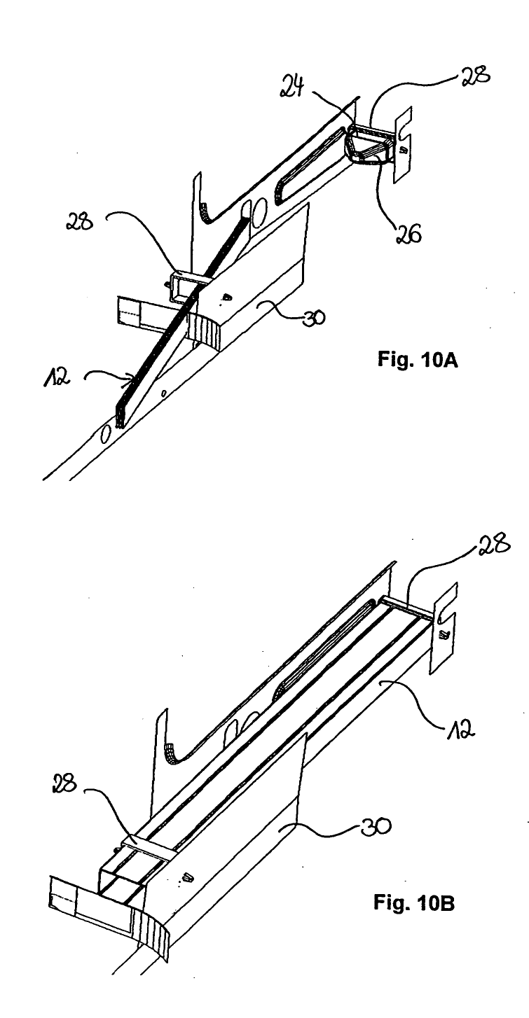

The take-up cassette 4 also includes an end terminating element 24 with which the housing 12 is closed off at the end. This terminating element 24 has a centering shoulder 26 (see FIG. 10A) that extends into the receptacle space 18 and that is embodied in the manner of a truncated cone.

To attach the take-up cassette 4 to the bodywork, a mounting frame 28 with attachment elements, for example, attachment pins, is provided. The terminating element 24 at the same time also forms such a mounting frame 28.

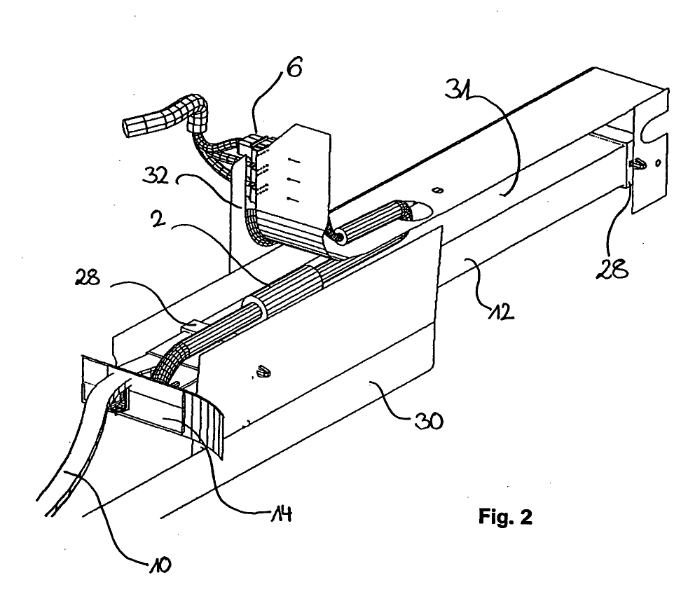

According to the exemplary embodiment in accordance with FIG. 2, the take-up cassette 4 is introduced into the cavity of a doorsill 30 of a motor vehicle bodywork. The cavity forms, here, a mounting space 31 for the take-up cassette 4. Specifically, in the exemplary embodiment in FIG. 2, the take-up cassette 4 is disposed in the region of the B pillar 32 (indicated only schematically), that is to say, the vertical bodywork pillar between, for example, the front seat passenger's door and the sliding door. The take-up cassette 4 is connected to the bodywork by the attachment elements of the mounting frames 28. The geometry of the take-up cassette 4 and that of the housing 12 are selected here such that the mounting space 31 that is available in the door sill 30 is used up as completely as possible, in particular, the width of the take-up cassette 4 corresponds approximately to the internal width of the door sill 30 so that the mounting frames 28 bear directly against the inside of the bodywork elements of the doorsill 30.

Due to the fact that the available width in the mounting space 31 is used completely, the housing 12 cannot be introduced into the doorsill 30 with the desired final geometry. For this reason, the housing 12, which is flexible and can be varied during mounting to form the desired final geometry, is provided.

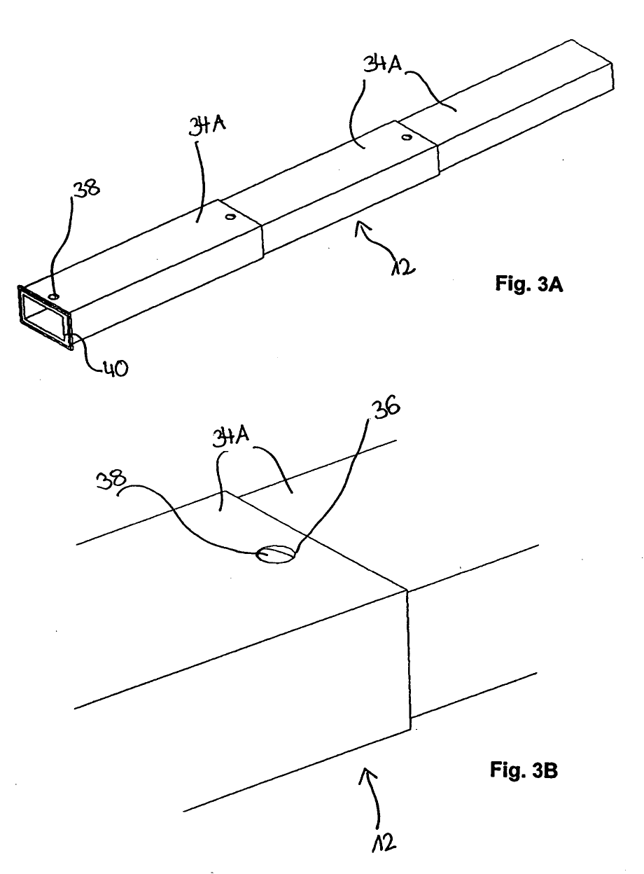

According to the embodiment according to FIGS. 3A, 3B, the housing 12 is divided into a plurality of component pieces 34A that can be displaced one in the other in the manner of a telescope. In their extended position, the pieces 34A can be latched to one another. Specifically, a respective component piece 34A has a latching opening 36 at its rear end in a side wall of the housing 12, and, at its front end, a latching projection 38—of a complementary configuration with respect to the opening 36—with insertion slope. The front component piece 34A of the housing 12 has an end frame 40.

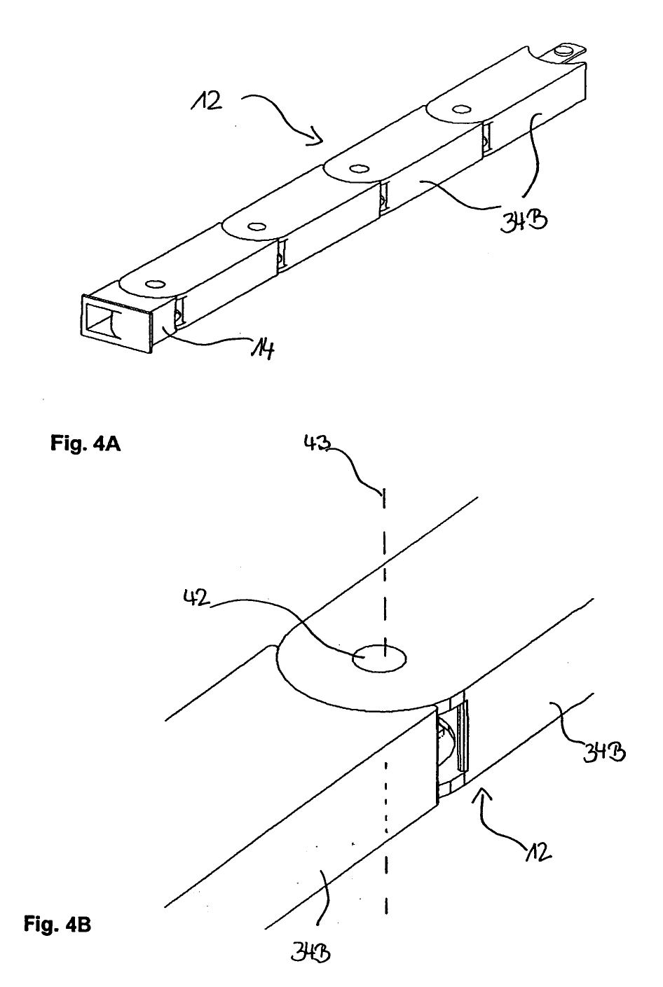

According to FIGS. 4A, 4B, individual component pieces 34B are provided that engage one in the other in the manner of a bearing shell, in a fashion such that they are complementary to one another, at their end sides that are aligned with one another. Specifically, the wide side walls are configured with a convex or concave curvature. The individual component pieces 34B each have, at the rear end of their wide side walls, two centrally disposed bearing pins 42 that form a bearing axis 43. At their front end, the component pieces 34B have pin receptacles that are disposed centrally so as to correspond to the latter. Successive component pieces 34B are, therefore, connected in the manner of a chain of elements that can be pivoted with respect to one another on both sides about the bearing axis 43. The insertion element 14 is similarly connected in the manner of a chain of elements to the front-most component piece 34B of the housing 12.

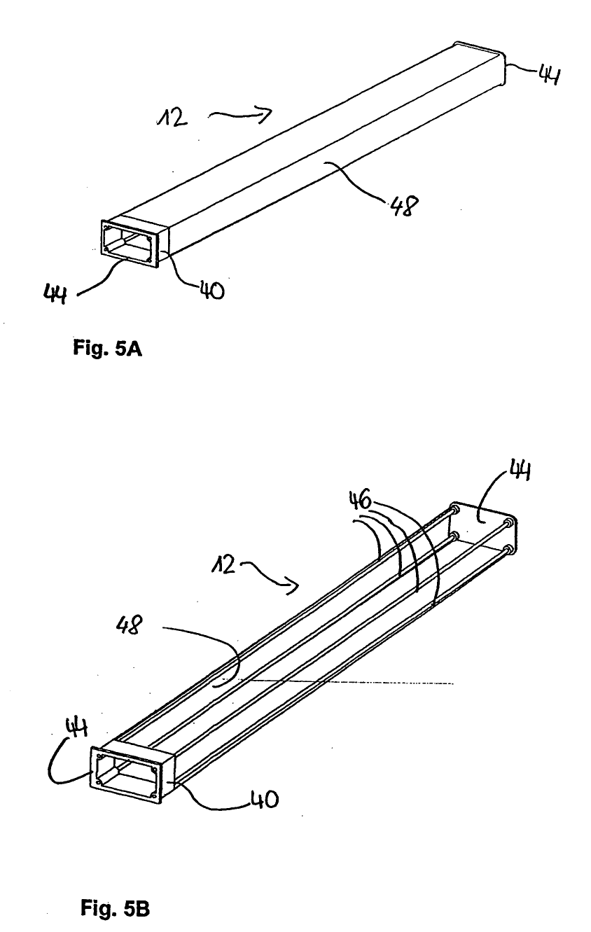

According to the exemplary embodiment in FIGS. 5A, 5B, the housing 12 includes two dimensionally stable ends 44 that lie opposite one another, the rear end 44 being embodied as a plate and the front end 44 as a frame 40. The two ends 44 are connected to one another by rods 46, the front end 44 that is embodied as a frame 40 being capable of being displaced along the rods 46 with respect to the rear end 44. The rods 46, therefore, form a guide element for the front end 44. The side walls of the housing 12 are formed by an elastic material, in particular, a textile covering 48 so that the ends 44 can easily be displaced with respect to one another along the rods 46. The textile covering 48 is illustrated only partially in FIG. 5B to illustrate better the structure with the rods 46. For the purpose of mounting, the two ends 44 are firstly pushed one onto the other so that the housing 12 has only a very short length. The rods 46 have a sufficient elasticity in order, for example, to combine them at their front ends so that overall the housing 12 can be inserted into the doorsill 30.

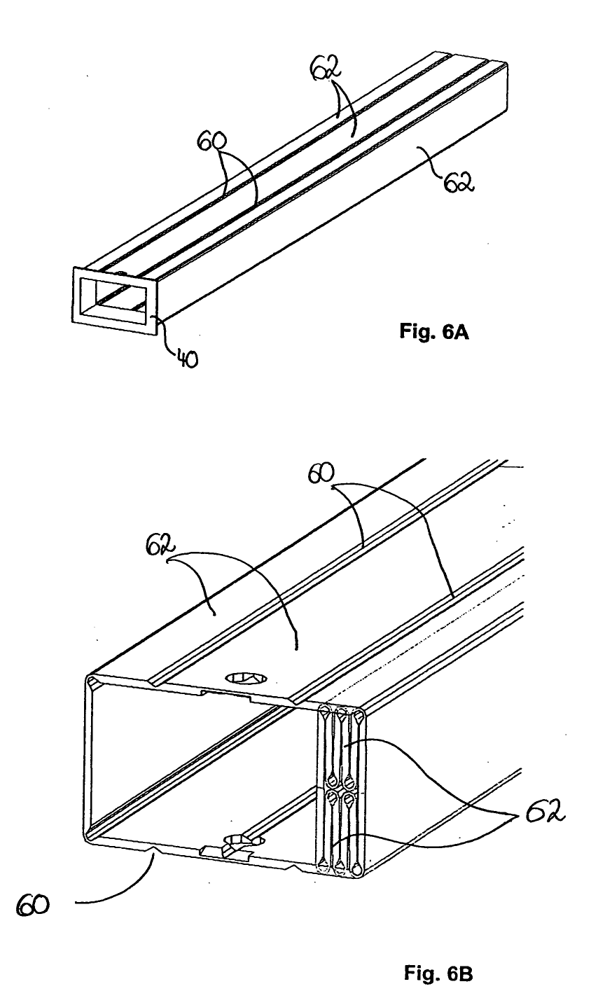

According to the exemplary embodiment in FIGS. 6A, 6B, the housing 12 is foldable, specifically, it can be folded transverse with respect to its longitudinal direction, i.e., individual folding elements 62 that are bounded by folding lines 60 extend in the longitudinal direction. In the exemplary embodiment the housing 12 is a plastic injection molded part, while, in the region of the folding lines 60, there is a material tapering in the form of a V-shaped notch so that the folding elements 62 can be considered to be individual plastic panels that are connected to one another by a film hinge. To illustrate the fold FIG. 6B shows a perspective partial detail that represents the housing 12 both in the folded open and in the folded state.

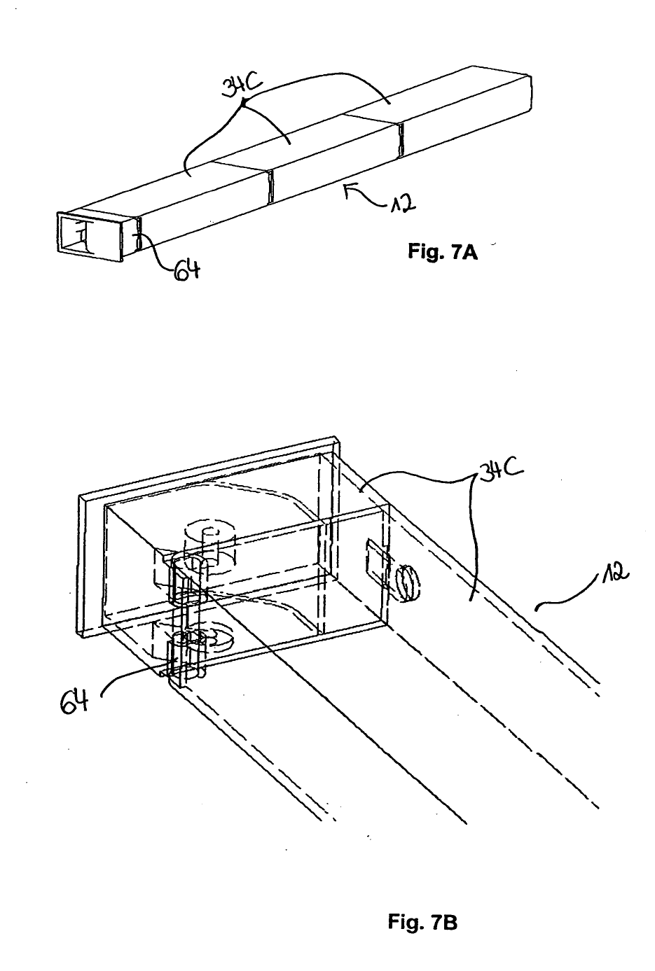

The housing 12 according to the exemplary embodiment in accordance with FIGS. 7A, 7B, in turn, includes a plurality of component pieces 34C that are connected to one another so as to be pivotable at the edge by a hinge 64. The individual component pieces 34C can, therefore, be folded against one another. The hinge 64 is, in particular, configured such that, here, it is locked as soon as the individual component pieces 34 are in the linearly extending end position in which successive component pieces 34C are aligned respectively with one another. The individual component pieces 34C can, then, no longer be pivoted against one another. For this reason, in the final mounted position, the individual component pieces 34C are latched to one another by the hinge 64.

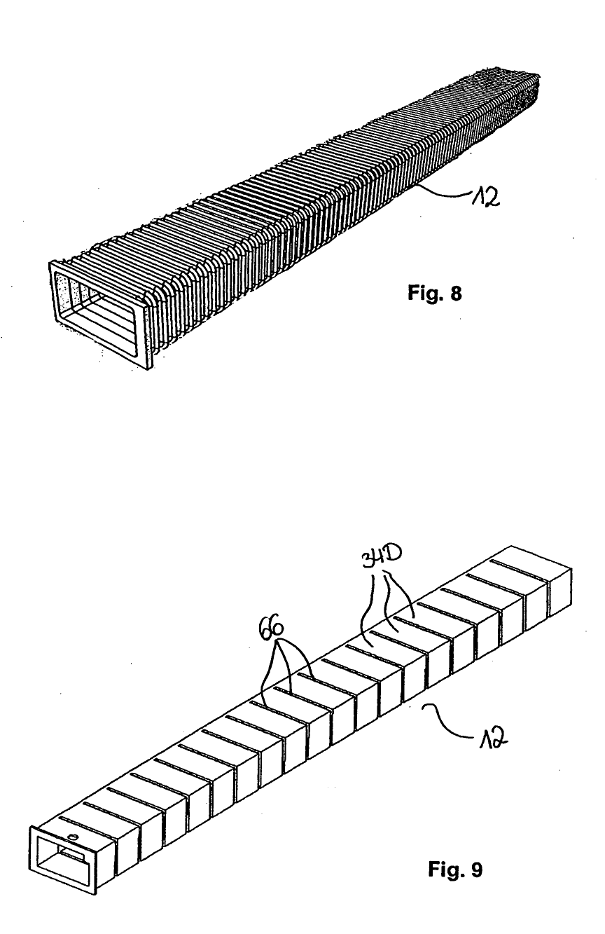

In the exemplary embodiment according to FIG. 8, the housing 12 is constructed overall in the manner of a corrugated tube with rectangular cross-section. The housing 12 is composed of a plastic, the wall thickness of the housing, preferably, being selected such that the housing 12 is flexurally elastic.

According to the variant in accordance with FIG. 9, movement slots 66 are provided, which extend from one of the side walls of the housing to the opposite, non-slotted side wall. The movement slots 66 are introduced at equal intervals transverse with respect to the longitudinal extent so that, as it were, individual component pieces 34D are formed that are connected to one another by the unslotted side wall. By forming the movement slots 66, the housing is made flexible, in particular, also flexurally elastic so that it can be bent about a bending axis that extends perpendicularly with respect to the longitudinal axis and parallel to the unslotted side wall. The unslotted side wall may have, here, individual weakened portions of material in the region of the movement slots 66 so that it is formed in the manner of a film hinge at these locations and permits the individual component pieces 34D to pivot with respect to one another.

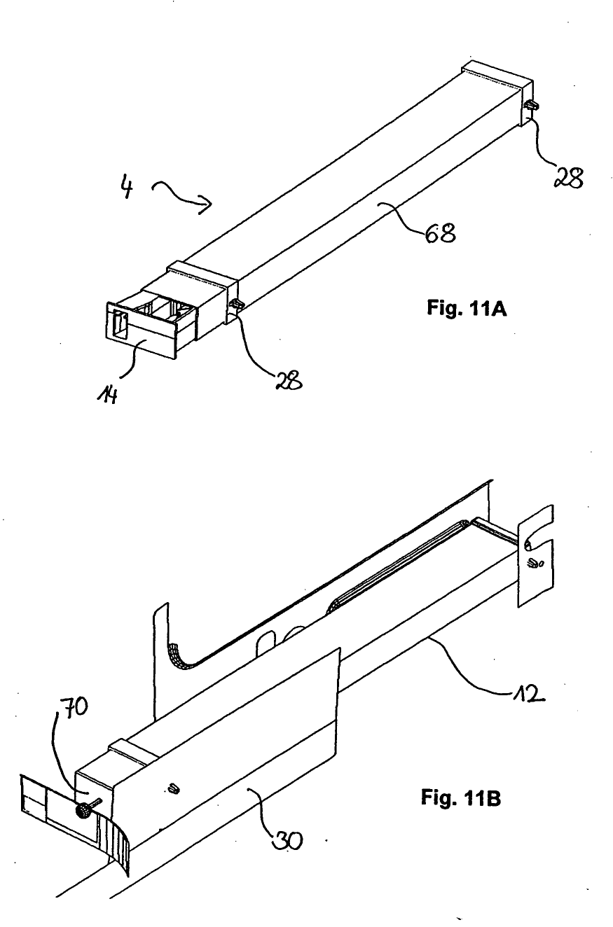

The mounting of a housing 12 will be explained with respect to FIGS. 10A and 10B using the example of the foldable housing 12. At first, the mounting frames 28 or the termination element 24 is attached with the centering shoulder 26 in the doorsill 30. The mounting frames 28 form part of the bodywork here. In the next step, the housing 12 is, then, introduced in the folded state. Due to the short width, this is easily possible. As soon as the folded housing 12 is introduced into the mounting space, it is folded up and pushed by its rear end over the connecting element 24 through the centering shoulder 26 so that it is sealed as tightly as possible at its rear side. In subsequent mounting steps (not illustrated here in more detail), the cable 2 is, then, threaded into the B pillar 32 (see FIG. 2) through the corresponding bodywork parts, for example, of the doorsill 30. The insertion element 14 is, then, mounted at the front end of the housing 12 and the cable 2, which is partially guided in the chain 8 of elements, is placed in the insertion element 14. The insertion element 14 is not closed with its upper part 14b until after the cable 2 has been inserted (cf. in this respect FIGS. 1A, 1B, and 2). As an alternative to this embodiment of the housing 12 with the variable housing geometry, it is also possible under certain circumstances, to use a dimensionally stable housing 68 for the take-up cassette 4. This dimensionally stable housing 68 is, then, connected, for example, in a very early stage of the construction of the bodywork, to a bodywork shell in the region of the doorsill 30 by the mounting frames 28 if there is still sufficient mounting space available for this. Because the bodywork is still treated, in particular, surface-coated, at this time of the mounting of the bodywork shell, according to FIG. 11B, a protective cap 70 is provided that closes off the end opening of the dimensionally stable housing 68. The protective cap 70 is replaced by the two-component insertion element 14 (cf. FIG. 11A) in subsequent mounting steps.

This application claims the priority, under 35 U.S.C. § 119, of German patent application No. 103 52 207.6, filed Nov. 5, 2003 and German patent application No. 103 57 139.6, filed Dec. 6, 2003; the entire disclosure of the prior applications are herewith incorporated by reference.

1. A take-up cassette for holding a cable of a sliding guide device and for being mounted in a constricted mounting space, comprising:
a housing having a final mounted position and a predefined final geometry in said final mounted position, said housing having a variable geometry with respect to said predefined final geometry for mounting said housing in said final mounted position.

2. The take-up cassette according to claim 1, wherein said housing has a plurality of component pieces moving in relation to one another for mounting said housing in said final mounting position.

3. The take-up cassette according to claim 2, wherein said component pieces are telescopic and pull apart from one another telescopically.

4. The take-up cassette according to claim 2, wherein said component pieces are each connected pivotably to one another.

5. The take-up cassette according to claim 4, wherein:
said housing has hinges; and
said component pieces have edges and are attached to one another by a respective one of said hinges disposed at a respective one of said edges.

6. The take-up cassette according to claim 4, wherein:
said component pieces have end sides and form a bearing shell on said end sides; and
said end sides are connected to one another in a respectively complementary manner with respect to one another and are pivotably attached to one another to pivot about a central bearing axis on both of said end sides.

7. The take-up cassette according to claim 2, wherein said component pieces are latched to one another in said final mounted position.

8. The take-up cassette according to claim 1, wherein said housing has:
two ends disposed opposite one another along a longitudinal extent;
a guide element; and
at least one of said ends displaces along said guide element in said longitudinal extent for mounting said housing.

9. The take-up cassette according to claim 8, wherein said housing has textile side walls.

10. The take-up cassette according to claim 1, wherein said housing is foldable.

11. The take-up cassette according to claim 1, wherein said housing has folding parts and folds on at least one of said parts.

12. The take-up cassette according to claim 1, wherein said housing is a corrugated tube.

13. The take-up cassette according to claim 1, wherein said housing has a longitudinal axis and movement slits distributed over said longitudinal axis, said slits being disposed transversely with respect to said longitudinal axis.

14. The take-up cassette according to claim 1, wherein said housing has a textured base.

15. A take-up cassette for holding a cable of a sliding guide device and for being mounted in a constricted mounting space, comprising:
a housing having a final mounted position and a predefined final geometry in said final mounted position, said housing having:
a variable geometry with respect to said predefined final geometry for mounting said housing in said final mounted position; and
a plurality of component pieces moving in relation to one another for mounting said housing in said final mounting position.

16. A take-up cassette for holding a cable for electrically connecting a sliding door to the onboard power system of a motor vehicle, comprising:
a housing having a final mounted position and a predefined final geometry in said final mounted position, said housing having a variable geometry with respect to said predefined final geometry for mounting said housing in said final mounted position.

17. A method for mounting a take-up cassette for a cable of a sliding guide device in a constricted mounting space, which comprises:
providing a take-up cassette with a housing having a variable geometry;
introducing the take-up cassette into the mounting space during mounting; and
changing the geometry of the housing in at least one of the mounting process of the housing; and
subsequent to the mounting process of the housing,
to form a predefined final geometry of the housing.

18. A method for mounting a take-up cassette for a cable of a sliding guide device in a constricted mounting space in a bodywork element of a motor vehicle for electrically connecting a sliding door to an onboard power system of a motor vehicle, which comprises:
providing a take-up cassette with a housing having a variable geometry;
introducing the take-up cassette into the mounting space during mounting; and
changing the geometry of the housing in at least one of the mounting process of the housing; and
subsequent to the mounting process of the housing,
to form a predefined final geometry of the housing.

19. A method for mounting a take-up cassette for a cable of a sliding guide device in a sliding door of a motor vehicle for electrically connecting a sliding door to an onboard power system of a motor vehicle, which comprises:
introducing a take-up cassette having a housing with a variable geometry into a constricted mounting space in a bodywork element of a motor vehicle; and
changing the geometry of the housing in at least one of the mounting process of the housing; and
subsequent to the mounting process of the housing,
to form a predefined final geometry of the housing.
